(19) United States
(12) Patent Application Publication
(10) Pub. No.: US 2014/0376034 A1
(43) Pub. Date: Dec. 25, 2014

(54) IDENTIFICATION OF PRINTERS

(71) Applicant: HEWLETT-PACKARD DEVELOPMENT COMPANY, L.P., Houston, TX (US)

(72) Inventors: Lenin Fernandes, Bangalore (IN); Kumaravel Ganesan, Bangalore (IN); Daniel Varghese, Bangalore (IN)

(21) Appl. No.: 13/923,997

(22) Filed: Jun. 21, 2013

(51) Int. Cl. G06F 3/12

(52) U.S. Cl. CPC G06F 3/126; G06F 3/1285
USPC 358/1.15

(57) ABSTRACT

A system for identifying printers is disclosed herein. An example includes a network and a plurality of printers coupled to the network. The system also includes a device coupled to the network that transmits a current location to the network and a server coupled to the network to produce a map of printers within a proximity of the device based on the current location of the device. The system additionally includes an application associated with the device to selectively produce a sound on at least one of the printers to help identify a location of the printer and to transmit a print job to the identified printer. Other elements and features of the system are disclosed herein, as are examples of a method for identifying networked printers and a non-volatile storage medium.

### BACKGROUND

Consumers appreciate quality and value in their printers. They also may want to use one or more printers that are part of a network. Designers and manufactures may, therefore, endeavor to create and supply solutions that are directed to accomplishing one or more of these objectives.

### BRIEF DESCRIPTION OF THE DRAWINGS

The following detailed description references the drawings, wherein:

FIG. 1 is an example of a system for identifying printers.

FIG. 2 is an example of a map of printers within a proximity of a device.

FIG. 3 is an example of a method for identifying networked printers.

FIG. 4 is an example of additional elements of the method for identifying networked printers of FIG. 3.

FIG. 5 is an example of a non-volatile storage medium having instructions executable by a processor.

FIG. 6 is an example of the non-volatile storage medium of FIG. 5 including additional instructions executable by the processor.

### DETAILED DESCRIPTION

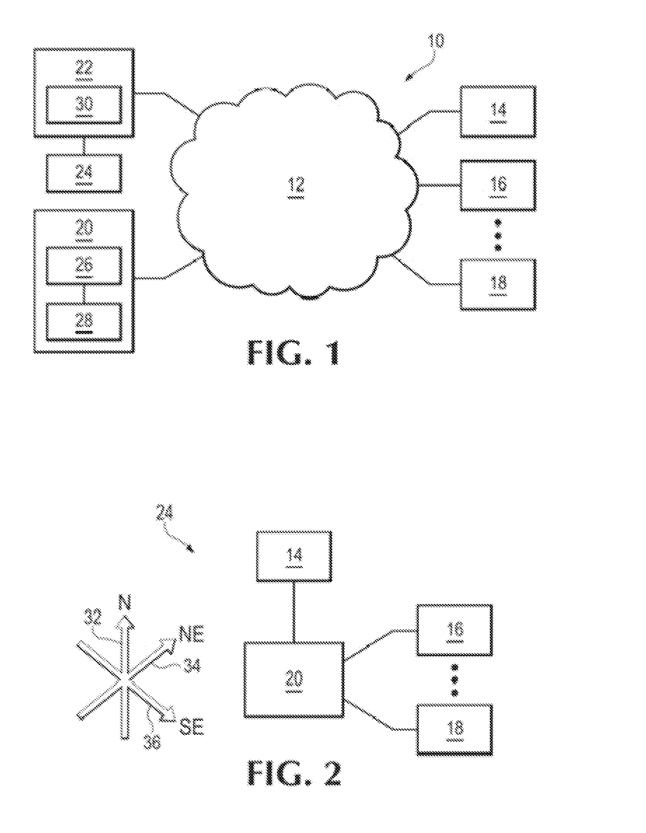

Device users may want to print items such as documents, photos, tickets, directions, etc. However, such device users may not know the location of any nearby printers. Such users may also not have the necessary driver for a particular printer installed on their device. Additionally, installation of drivers can be challenging and/or time-consuming for some device users which is undesirable. An example of a system for identifying printers 10 that is directed to addressing these challenges is illustrated in FIG. 1.

As used herein, the term “cloud” is defined as including, but not necessarily limited to, computing resources (hardware, software, and firmware) that are delivered as a service over a network (such as the internet). As used herein, the term “network” is defined as including, but not necessarily limited to, one or more connections between devices, systems, servers, applications and/or users that allow transfer and exchange of data and information. Networks may be wired and/or wireless, and utilize a variety of different topologies, transmission media, and protocols.

As used herein, the term “non-volatile storage medium” is defined as including, but not necessarily limited to, any media that can contain, store, retain, or maintain programs, code, scripts, information, and/or data. A non-volatile storage medium may include any one of many physical media such as, for example, electronic, magnetic, optical, electromagnetic, or semiconductor media. A non-volatile storage medium may be a component of a distributed system. More specific examples of suitable non-volatile storage media include, but are not limited to, a magnetic computer diskette such as floppy diskettes or hard drives, magnetic tape, a read-only memory (ROM), an erasable programmable read-only memory (EPROM), a flash drive, a compact disc (CD), a digital video disk (DVD), or a memristor.

As used herein, the term “processor” is defined as including, but not necessarily limited to, an instruction execution system such as a computer/processor based system, an Application Specific Integrated Circuit (ASIC), a computing device, or a hardware and/or software system that can fetch or obtain the logic from a non-volatile storage medium and execute the instructions contained therein. “Processor” can also include any controller, state-machine, microprocessor, cloud-based utility, service or feature, or any other analogue, digital and/or mechanical implementation thereof. A processor may be a component of a distributed system.

As used herein, the term “printer” is defined as including, but not necessarily limited to, a peripheral that produces a representation of a document on one or both sides of media such as paper, transparency, fabric, etc. A printer can be single function or multi-function (e.g., including scanning, faxing, or other functionality). A printer can use any of a variety of different types of marking technologies such as laser, inkjet, dye-sublimation, off-set printing, thermal printing, impact, etc. As used herein, the term “distributed system” is defined as including, but not necessarily limited to, multiple processors and non-volatile storage media in different locations or systems that communicate via a network, such as the cloud.

As used herein, the term “device” is defined as including, but not necessarily limited to, at least one computer, server, smart or mobile phone, terminal, tablet, personal digital assistant, peripheral or other similar device. As used herein, the term “server” is defined as including, but not necessarily limited to, at least one computer, program, or combination thereof that processes requests, delivers data or other information, or provides one or more services over the cloud and/or a network.

As used herein, the term “application” is defined as including, but not necessarily limited to, a program, software, and/or firmware that causes a device to perform or assist a device in performing one or more tasks such as word processing, financial analysis, reporting, presentations, communications, etc. As used herein, the term “print job” is defined as data, a file, or a set of files that have been submitted to be printed by a printer. As used herein, the term “driver” is defined as including a program, software, and/or firmware that converts (i.e., renders) a print job to a format or form specific to a printer.

Referring again to FIG. 1, system 10 includes a network 12 and a plurality of printers (in this example printer 14, printer 16 through printer 18) coupled to network 12. System 10 also includes a device 20 coupled to network 12 that transmits a current location to network 12 (by, for example, use of the Global Positioning System (GPS)), and a server 22 coupled to network 12. Server 22 produces a map 24 of printers within a proximity of device 20 based on the current location of device 20. System 10 additionally includes an application 26 associated with device 20 (e.g., executed by an operating system of device 20) to selectively produce a sound on at least one of printers 14 through 18 to help a user of device 20 to identify a location of that printer. The user of device 20 can then utilize application 26 to transmit a print job 28 to that identified printer.

The sound produced by at least one of printers 14 through 18 may be generated by a speaker inside the printer. Alternatively, application 26 may produce the sound by selectively turning the printer off and then on. As another example, application 26 may actuate the printer by initiating a service station routine in those instances where the printer is an inkjet printer.

Print job 28 may be transmitted to the identified printer by application 26 via network 12. alternatively or additionally, server 22 may include a driver 30 for the identified printer to render transmitted print job 28. This helps users of device 20 so that they do not have to locate and install the correct driver 30 for the identified printer on device 20 which can be time consuming and challenging for at least some users.

Each of printers 14 through 18 may transmit location information to server 22. This may by accomplished in a variety of different ways such as, for example, use of the Global Positioning System (GPS)). As another example, the location of each of printers 14 through 18 may be provided to server 22 by virtue of the particular internet protocol (IP) addresses of each printer.

An example of map of printers 24 within a proximity of device 20 is shown in FIG. 2. may 24 may be displayed on device 20 (e.g. a screen) and may include a name (e.g., Laserjet printer, inkjet printer, etc.) of each of printers 14 through 18. Also or alternatively, map 24 may indicate a direction of each of printers 14 through 18 relative to device 20 (e.g., printer 14 is to the north 32, printer 16 is to the northeast 34, and printer 18 is to the southeast 36). Alternatively or additionally, may 24 may indicate a location of each of printers 14 through 18 (e.g., printer 14 is located in the workroom, printer 16 is located in building 2 near pole J3, and printer 18 is located in the library atrium). May 24 may further or alternatively indicate a distance of each of printers 14 through 18 from device 20 (e.g., printer 14 is 100 feet away, printer 16 is approximately 1/10^{th} of a mile away, and printer 18 is 10 meters away).

The ability to selectively produce a sound on printers 14 through 18 in combination with map 24 help device 20 users more easily identify and select available printers within their proximity. It also helps such device 20 users more readily retrieve their completed print jobs from printers 14 through 18. This allows device 20 users to more easily take advantage of networked printers 14 through 18 than they might otherwise be able to do without this combination of features.

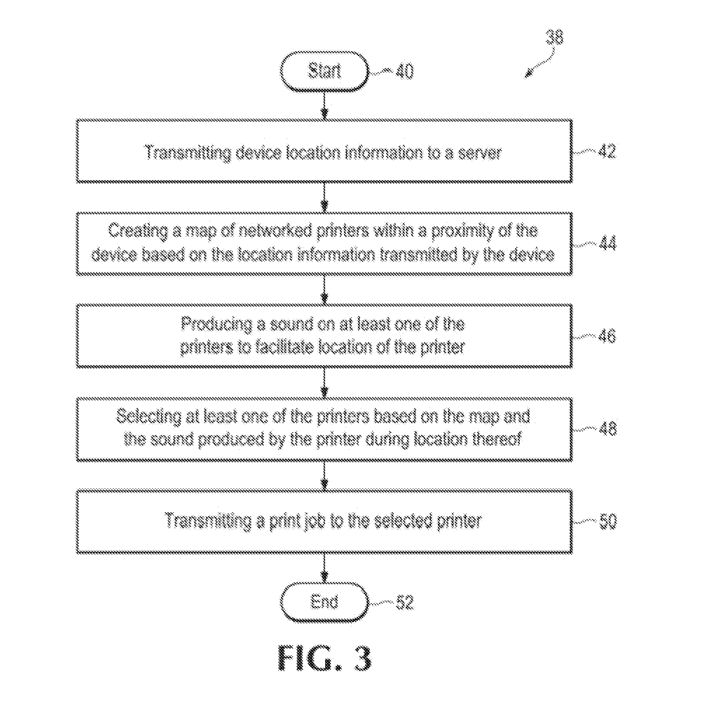

An example of a method for identifying networked printers 38 is shown in FIG. 3. As can be seen in FIG. 3, method 38 starts 40 by transmitting device location information to a server, as indicated by block 42, and creating a map of networked printers within a proximity of the device based on the location information transmitted by the device, as indicated by block 44. method 38 continues by producing a sound on at least one of the printers to facilitate location of the printer, as indicated by block 46, and selecting at least one of the printers based on the map and the sound produced by the printer during location thereof, as indicated by block 48. Method 38 may then continue by transmitting a print job to the selected printer, as indicated by block 50, and then ending or concluding 52.

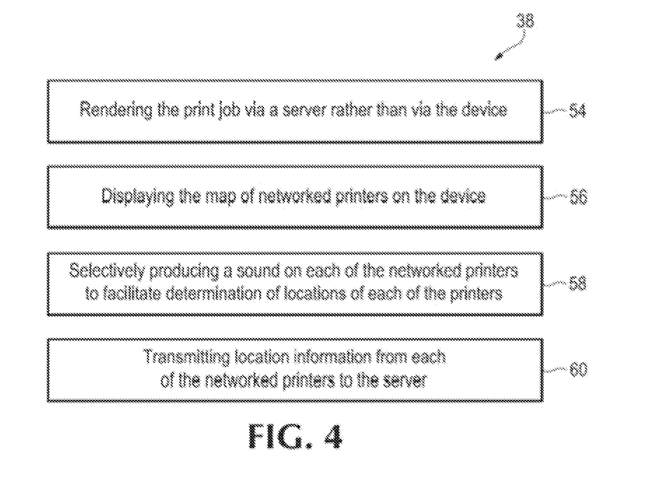

An example of additional elements of method for identifying networked printers 38 is shown in FIG. 4. In those instances where the server is coupled to the device and each of the network printers, method 38 may additionally include the element of rendering the print job via a server rather than via the device, as indicated by block 54. Method 38 may alternatively or additionally include the element of displaying the map of networked printers on the device, as indicated by block 56, and/or the element of selectively producing a sound on each of the networked printers to facilitate determination of locations of each of the printers, as indicated by block 58.

The map of networked printers may be created based on the location information transmitted from each of the networked printers. In such cases, method 28 may include the element of transmitting location information from each of the networked printers to the server, as indicated by block 60. The map may include a name of each of the printers, a direction of each of the printers relative to the device, a location of each of the printers, and/or a distance of each of the printers from the device.

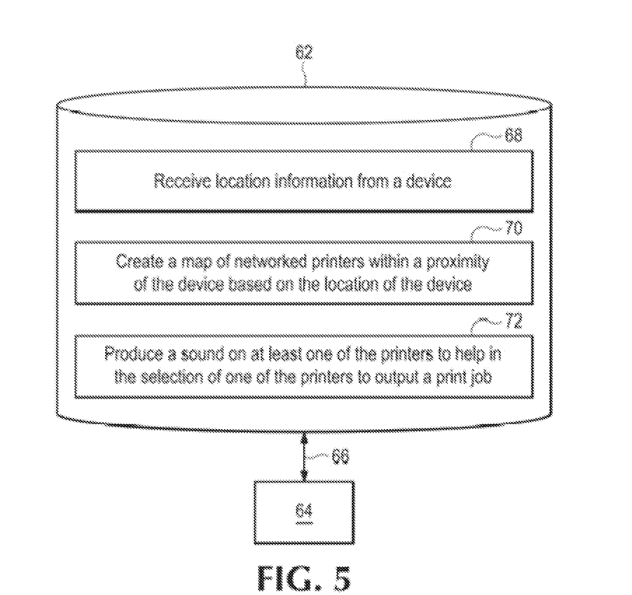

An example of a non-volatile storage medium 62 having instructions executable by a processor 64, as generally indicated by double-headed arrow 66, is shown in FIG. 5. As can be seen in FIG. 5, non-volatile storage medium 62 includes instructions that, when executed by processor 64, cause processor 64 to receive location information from a device, as indicated by block 68. Non-volatile storage medium 62 includes additional instructions that, when executed by processor 64, cause processor 64 to create a map of networked printers within a proximity of the device based on the location of the device, as indicated by block 70, and to produce a sound on at least one of the printers to help in the selection of one of the printers to output a print job, as indicated by block 72.

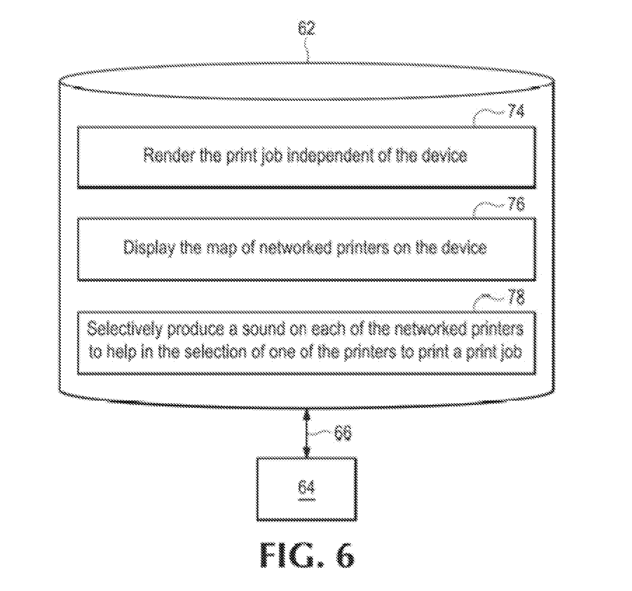

An example of non-volatile storage medium 62 including additional instructions executable by the processor 64, as generally indicated by double-headed arrow 66, is shown in FIG. 6. As can be seen in FIG. 6, non-volatile storage medium 62 may include additional instructions that, when executed by processor 64, cause processor 64 to render the print job independent of the device, as indicated by block 74. Non-volatile storage medium 62 may alternatively or additionally include instructions that, when executed by processor 64, cause processor 64 to display the map of networked printers on the device, as indicated by block 76, and/or to selectively produce a sound on each of the networked printers to help in the selection of one of the printers to print a print job, as indicated by block 78.

The map of networked printers may be created based on the location information transmitted from each of the networked printers. The map may include a name of each of the printers, a direction of each of the printers relative to the device, a location of each of the printers, and/or a distance of each of the printers from the device.

Although several drawings have been described and illustrated in detail, it is to be understood that the same are intended by way of illustration and example only. These examples are not intended to be exhaustive or to be limited to the precise form disclosed. Modifications and variations may well be apparent to those of ordinary skill in the art.

Additionally, reference to an element in the singular is not intended to mean one and only one, unless explicitly so stated, but rather means one or more. Moreover, no element or component is intended to be dedicated to the public regardless of whether the element or component is explicitly recited in the following claims.

What is claimed is:

1. A system for identifying printers, comprising:
a network;
a plurality of printers coupled to the network;
a device coupled to the network that transmits a current location to the network;
a server coupled to the network to produce a map of printers within a proximity of the device based on the current location of the device; and
an application associated with the device to selectively produce a sound on at least one of the printers to help identify a location of the printer and to transmit a print job to the identified printer.

2. The system of claim 1, wherein the print job is transmitted to the identified printer by the application via the network.

3. The system of claim 1, wherein the server includes a driver for the identified printer to render the transmitted print job.

4. The system of claim 1, wherein each of the printers transmits location information to the server.

5. The system of claim 1, wherein the map of printers is displayed on the device.

6. The system of claim 1, wherein the application selectively produces a sound on each of the printers to help identify locations of each of the printers.

7. The system of claim 1, wherein the map includes at least one of a name of each of the printers, a direction of each of the printers relative to the device, a location of each of the printers, and a distance of each of the printers from the device.

8. A method for identifying networked printers, comprising:
transmitting device location information to a server;
creating a map of networked printers within a proximity of the device based on the location information transmitted by the device;
producing a sound on at least one of the printers to facilitate location of the printer;
selecting at least one of the printers based on the map and the sound produced by the printer during location thereof; and
transmitting a print job to the selected printer.

9. The method of claim 8, further comprising rendering the print job via a server rather than via the device, wherein the server is coupled to the device and each of the networked printers.

10. The method of claim 8, further comprising displaying the map of networked printers on the device.

11. The method of claim 8, further comprising selectively producing a sound on each of the networked printers to facilitate determination of locations of each of the printers.

12. The method of claim 8, wherein the map includes at least one of a name of each of the printers, a direction of each of the printers relative to the device, a location of each of the printers, and a distance of each of the printers from the device.

13. The method of claim 8, further comprising transmitting location information from each of the networked printers to the server, wherein the map of networked printers is created based on the location information transmitted from each of the networked printers.

14. A non-volatile storage medium including instructions that, when executed by a processor, cause the processor to:
receive location information from a device;
create a map of networked printers within a proximity of the device based on the location of the device; and
produce a sound on at least one of the printers to help in the selection of one of the printers to output a print job.

15. The non-volatile storage medium of claim 14, further comprising additional instructions that, when executed by the processor, cause the processor to render the print job independent of the device.

16. The non-volatile storage medium of claim 14, further comprising additional instructions that, when executed by the processor, cause the processor to display the map of networked printers on the device.

17. The non-volatile storage medium of claim 14, further comprising additional instructions that, when executed by the processor, cause the processor to selectively produce a sound on each of the networked printers to help in the selection of one of the printers to print a print job.

18. The non-volatile storage medium of claim 14, wherein the map includes at least one of a name of each of the printers, a direction of each of the printers relative to the device, a location of each of the printers, and a distance of each of the printers from the device.

19. The non-volatile storage medium of claim 14, wherein the map of networked printers is created based on location information transmitted from each of the networked printers to the processor.

20. The non-volatile storage medium of claim 14, further comprising additional instructions that, when executed by the processor, cause the processor to display the map of networked printers on the device.
